(19) United States
(12) Patent Application Publication
(10) Pub. No.: US 2017/0357932 A1
(43) Pub. Date: Dec. 14, 2017

(54) Method, Apparatus and System for Appointment Scheduling and Management

(71) Applicant: Sujit Kumar Dalai, Fremont, CA (US)

(72) Inventor: Sujit Kumar Dalai, Fremont, CA (US)

(73) Assignee: CounterBean Inc., Fremont, CA (US)

(21) Appl. No.: 15/181,728

(22) Filed: Jun. 14, 2016

(51) Int. Cl. G06Q 10/06; G06Q 10/10

(52) U.S. Cl. CPC G06Q 10/063116; G06Q 10/1095

(57) ABSTRACT

An appointment scheduling and management system is proposed. Through the use of time blocks of fixed duration and de-linked to the service time of the clients, the entire process of scheduling, cancellation, change and alert methods of the appointment system are made more efficient in execution, less demanding on resources and computer system. Web based deployment is enabled through use of a central database with system operating on a plurality of platform, including mobile devices. All participants in the system gain on efficient use of time, less human interaction, more automation and user on-demand access to information live and most current.

### BENEFIT OF EARLIER FILING DATE FOR PRIORITY

This non-provisional patent application claims benefit of priority date through specific reference to provisional patent application No. 62/181,179 dated Jun. 17, 2015 under 35 U.S.C. 119 (e)(1). See also 37 C.F.R. 1.78.

### TECHNICAL FIELD

This invention relates to system used for the scheduling and management of appointments involving clients, service providers with each service provider capable of offering multiple services. The database and management of scheduling, cancellation and display of schedule is made more hardware and software efficient. Such efficiency enables implementation of the solution in mobile applications among others.

### BACKGROUND OF THE INVENTION

The proposed invention is intended for independent service providers to publish their schedule. This enables their customers to access the real time availability to be able to schedule and manage appointments. Traditionally, clients make a phone call, communicate through email or text service providers to know their schedules and availability. Since two way human intervention is required, the interaction is time consuming, not user driven and reliant on availability of a personnel involved in scheduling. If the personnel is unavailable, clients have to initiate the communication several times. If a subsequent change or cancellation is required, this inefficient process has to be repeated.

To overcome this problem, some web based solutions give availability picture of one service provider for fixed length appointments. This solution however becomes highly compute and resource intensive for a single software system managing schedule and appointments for many service providers as the volume of availability, unavailability, appointment creation, change and cancellation increase. Due to use of fixed duration appointments, service providers cannot provide flexible duration appointments. Also, when a service provider provides multiple services, the solution does not scale and becomes inefficient. This invention overcomes this inefficiency by introducing the use of time blocks of fixed but of duration independent of the service time a client schedules the service for. Due to this de-linking of the management of the scheduling process and database with the duration of time that the client demands, the management and running of the entire system becomes manageable and less cumbersome. Such an increased efficiency enables the implementation of the scheduling system on a plurality of platforms, including mobile platform through provision and installation of an application. The entire time domain used for scheduling is maintained as a linked list of time blocks of a pre-defined duration, which can be provided as a parameter to the system.

Through the use of fixed duration time blocks, completely de-linked to client's service time, the scheduling, change and cancellation of appointment becomes less cumbersome, less resource and compute demanding and efficient to implement. Similarly, the communication to all parties affected by these changes becomes timely and efficient, leading to superior time management. The use of the time blocks also enables the system to handle late arrival of clients and added service time (appointment going beyond its scheduled time) robustly, with minimum overhead.

### BRIEF DESCRIPTION OF THE DRAWINGS

FIG. 1 shows an illustration of a service offered by a service provider with a plurality of offerings. A single service with single offering is also shown.

FIG. 2 illustrates the concept of time block and the split of the entire time of a day into a plurality of time blocks.

FIG. 3 illustrates the use of time blocks in the processes to publish availability, publish unavailability, appointment request and appointment confirmation for a service provider.

FIG. 4 is a diagram illustrating, in one embodiment, collection of available time blocks that are not allocated to any confirmed appointment.

FIG. 5 is the same illustration showing net availability, which is a collection of available time blocks that neither have any appointment request nor allocated to any appointment.

FIG. 6 is a diagram illustrating in one embodiment, a remote server which maintains database and information, updated by various processes initiated by clients and service providers.

FIG. 7 is a diagram illustrating processes and steps involved in service registration where a user device provides service information and service offerings to be stored in a remote server for distributed access.

FIG. 8 illustrates in one embodiment, the management of the processes of availability and unavailability which involves creation, update or removal of time blocks.

FIG. 9 is a flowchart diagram showing the steps and processes involved in processing availability and unavailability in time block units.

FIG. 10 shows the present state of various time blocks stored in the remote server that provide a pictorial view of all available time blocks for appointment where request has been made and either confirmation is provided or it is not yet provided confirmation.

FIG. 11 pictorially illustrates the processing of an appointment creation request, tracing it from a user device to remote server, update of time block states and notification to all parties in interest.

FIG. 12 shows the effect of an appointment creation request on the time blocks, update of their status and appropriate logging and notification to the users.

FIG. 13 pictorially illustrates processing of a response appointment request with outputs to a decline or acceptance. Based on service, offering, time slot demand, a query is made to the remote server to determine the result and so convey to the user.

FIG. 14 illustrates the effect of an appointment request acceptance, where the time blocks are marked as utilized, a confirmation is sent and response activity is complete.

FIG. 15 illustrates the same effect of an appointment request denial, where the tentative marked time blocks are given back as available, a denial or cancellation is sent and the response activity is completed.

FIG. 16 pictorially illustrates processing of change of appointment request, in one case the appointment has been confirmed before and in the second case, the appointment has not been confirmed.

FIG. 17 shows the manipulation of time blocks and request processing of appointment change where previously never confirmed before.

FIG. 18 illustrates the same change in appointment request which had been confirmed before.

FIG. 19 shows an appointment cancellation process, issuance of a query by a user, generation of process and manipulations on the remote server based data structures.

FIG. 20 illustrates the cancel appointment process, manipulation of time block data structures, notifications and completion of process.

FIG. 21 shows the mechanics of a view schedule process, where a user initiates a query to access the remote server data base and appointment involving the user and overall availability is displayed.

FIG. 22 is illustrative of the solution space involving all operations and processes over the remote server.

FIG. 23 illustrates time blocks for two services S1 and S2 for a provider P1 for time slots 2 PM to 7 PM and 6 PM to 9 PM.

FIG. 24 graphically shows allocation of time blocks from 3 PM to 4 PM for S1 service and 6 PM to 7 PM for S2 service where S1 and S2 are offered together by provider P1.

FIG. 25 illustrates the cancellation of these appointments and release of the time slots.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

For purposes of this disclosure, an appointment scheduling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an appointment scheduling system may be a hardware device of size, shape, performance, functionality, and price. In another embodiment, it may comprise of software components capable of being loaded to run on a hardware device. The appointment scheduling system may include random access memory (RAM), one or more processing resources such as a central processing unit (CPU) or hardware or software control logic, read-only memory (ROM), and/or other types of nonvolatile memory. Additional components may include one or more disk drives, one or more network ports for communicating with external devices as well as various input and output (I/O) devices, such as a keyboard, a mouse, and a video display. The appointment scheduling system may also include one or more buses operable to transmit communications between the various hardware components. The appointment scheduling system may be dedicated system of hardware and software. In another embodiment, it may constitute transferable software code loadable and runnable on a general purpose computer system.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The present invention involves an interaction between clients and service providers advertising a plurality of service offerings. The entire mechanics is vested in a remote server, which maintains the status of time slots in units of time blocks. Each service provider joining the service platform advertises a number of services available for specified hours. In one embodiment, a single service provider provides a plurality of services (e.g. S1, S2 . . . ). In another embodiment, a plurality of service providers (P1, P2, P3 . . . ) may offer a single service or plurality of services. A user within the framework is either service seeker client or service provider. When the service provider is a user, a registration of service occurs through appropriate transaction initiated from an end point. For the scheduling of appointment, processes of managing availability, viewing availability, viewing schedule, notifying and changing, canceling or requesting an appointment are triggered. The time blocks are free, requested or confirmed and they change their state based on the appointment related transactions.

The time blocks are maintained in fixed duration of time, which is in smaller quanta than the time it takes to provide a complete service for an offering. Various buckets of time, be it free, requested or confirmed are maintained as links in a list or chain. The storage of the service provider availability in remote server as time blocks makes the real time scheduling software efficient and easy. In one embodiment, a performance improvement of 50% is seen. Such use of time blocks also allows management of a plurality of service providers with a plurality of service offerings and a plurality of time blocks where there is an overlap of multiple offerings with a single service provider. Variable appointment times are supportable along with fixed time appointments supported by state of the art solutions. Scalability is enhanced with minimum compute and resource overhead. With traditional approaches, as the volume of availability, unavailability, appointment creation, changes and cancellation increase, processing becomes highly computing resource intensive.

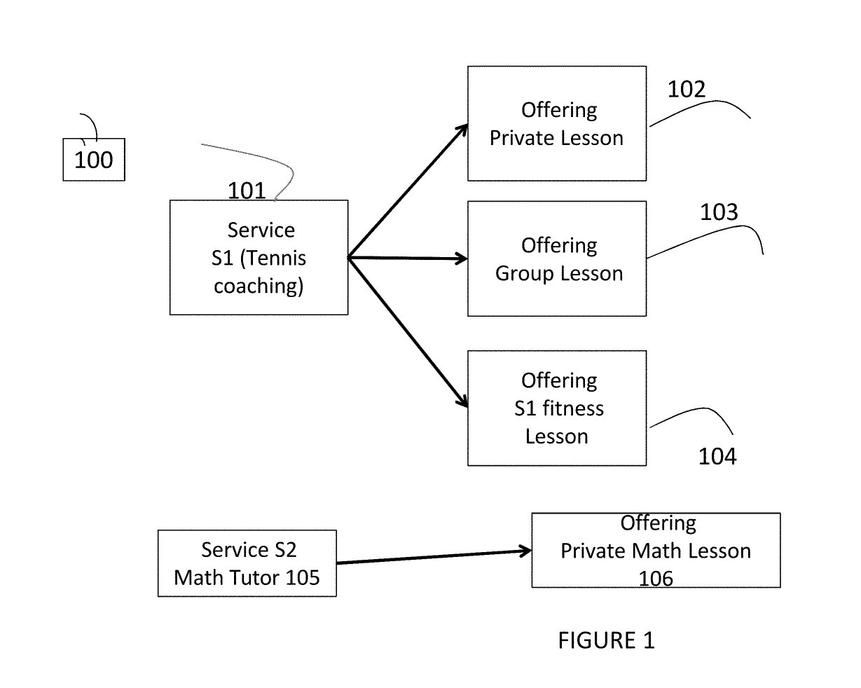

FIG. 1 100 illustrates a service and its attributes as used within an embodiment of an invention. A service 101 may offer a service S1 with a plurality of offerings. For example, a tennis coaching service 101 may offer a service with offerings of private lesson 102, group lesson 103 and fitness lesson 104. Plurality of offerings is supported, over a plurality of services provided by a plurality of service providers. The framework has been architected to absorb these with full scalability and minimum complexity and compute resource consumption. (A service provider can provide more than one service. Each service can have one or more service offerings.) A service S2 105 offers a single offering 106, as one embodiment of services supported.

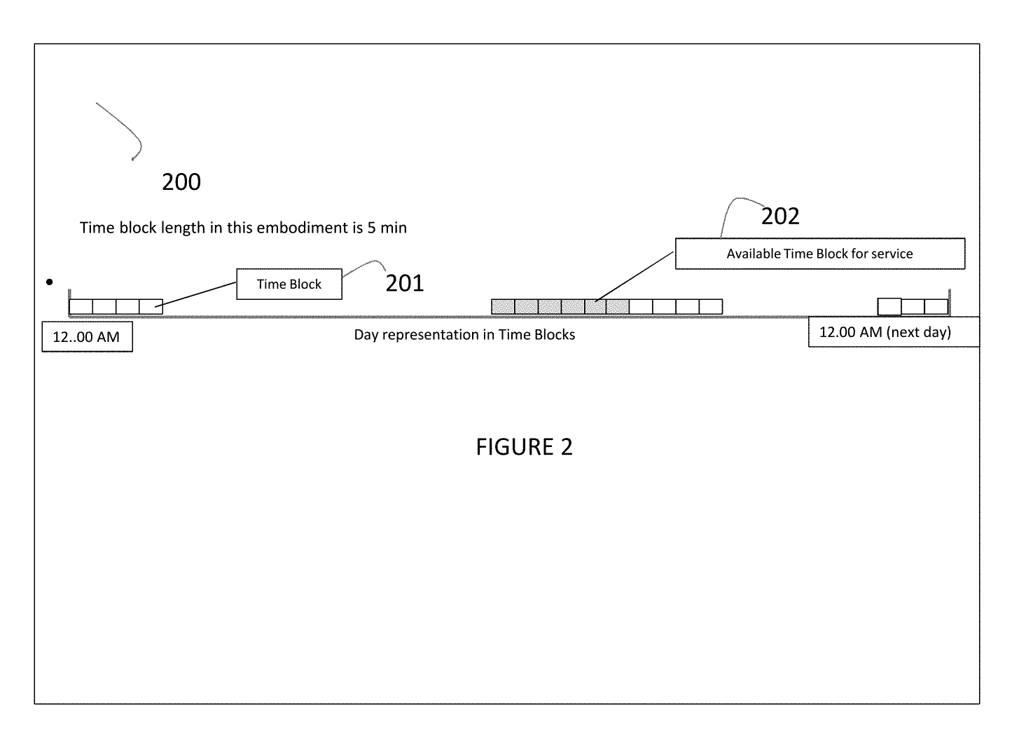

FIG. 2 200 illustrates the concept of time blocks within the context. A typical day is broken into time blocks of a plurality of 5-minute time blocks 201 as shown. Based on current status, a certain count of time blocks are available to be allocated to an appointment request 202, sometime blocks are already allocated, but not yet confirmed.

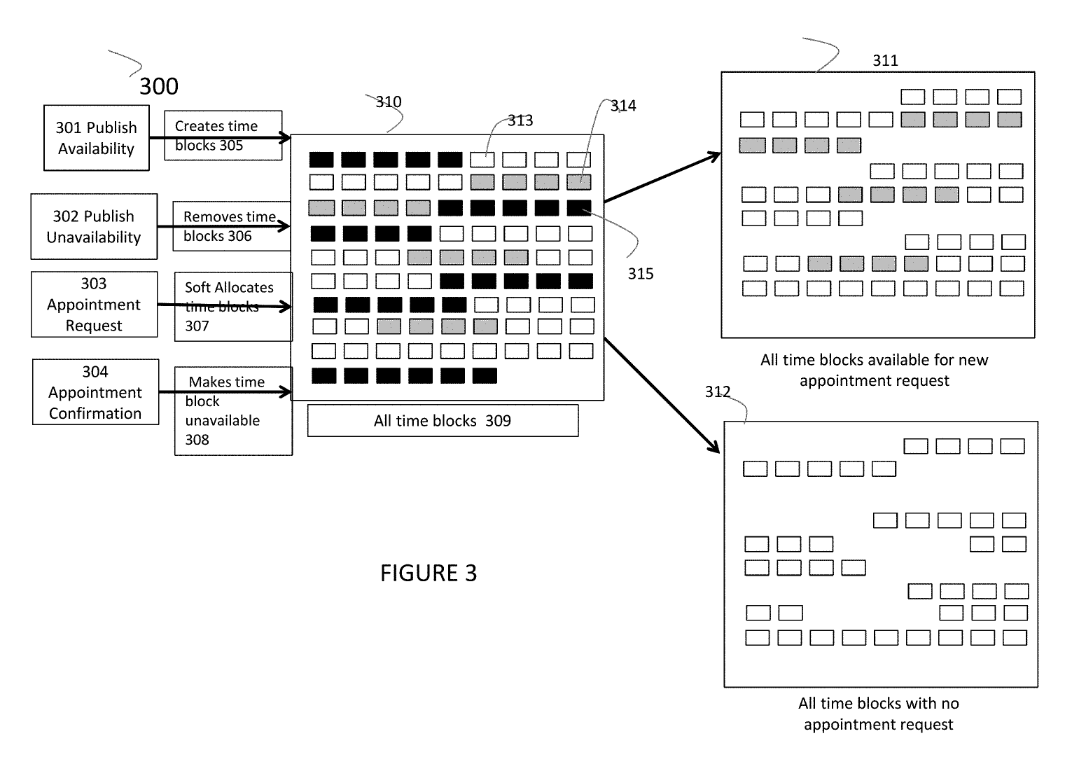

FIG. 3 300 illustrates publish availability 301 process which converts availability period into equivalent time blocks 305. This process then operates on all time blocks 309 to add new time blocks or update existing time blocks (confirmed 315, requested 314 or empty 313) to represent availability to be published for service. The present picture of the time blocks 310 is split into two blocks, one block 311 holds all time blocks which are empty or have been requested but not confirmed. A second block 312 displays all empty blocks with no appointment request. Similar to publish availability process, publish unavailability 302 removes time blocks for service 306 from availability. An appointment request 304 process soft allocates the blocks 307. An appointment confirmation 304 makes time block unavailable 308 for future appointment request.

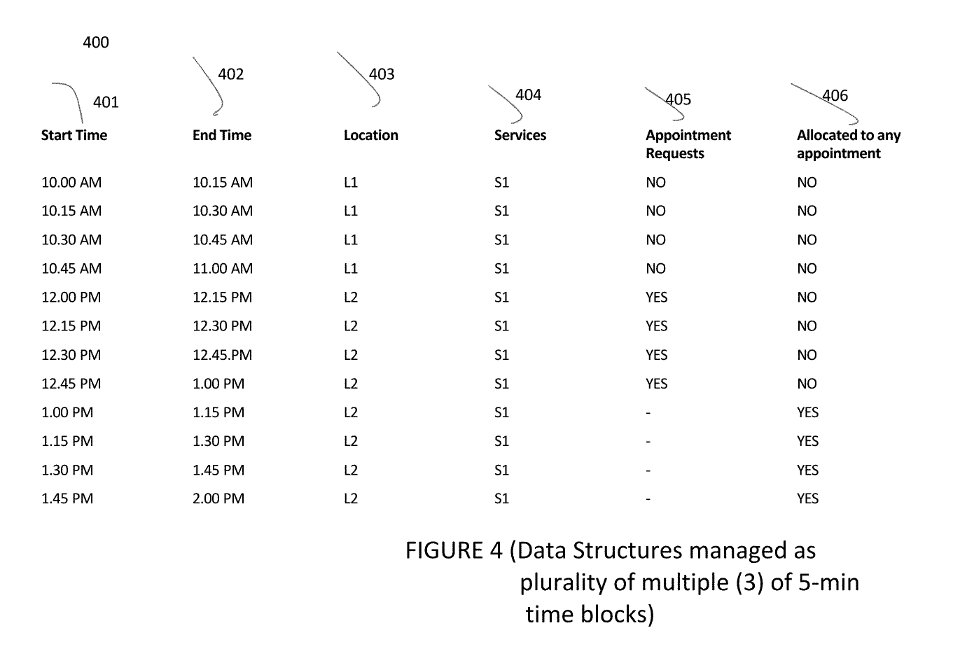

FIG. 4 400 illustrates the various time blocks as a table of attributes showing availability for new appointment request. Collections of available time blocks that are not allocated to any confirmed appointment are shown. Each group of consecutive time blocks meeting above criteria for a location is clubbed together as availability time for new appointment. The attributes are start time 401, end time 402, location 403, services 404, appointment request status 405 and allocation status 406. In one embodiment, the time blocks are in 5 minutes interval. Using the pictorial convention, the first four rows of the table represent empty blocks, the next four represent grey blocks requested and the next four rows represent the confirmed time blocks.

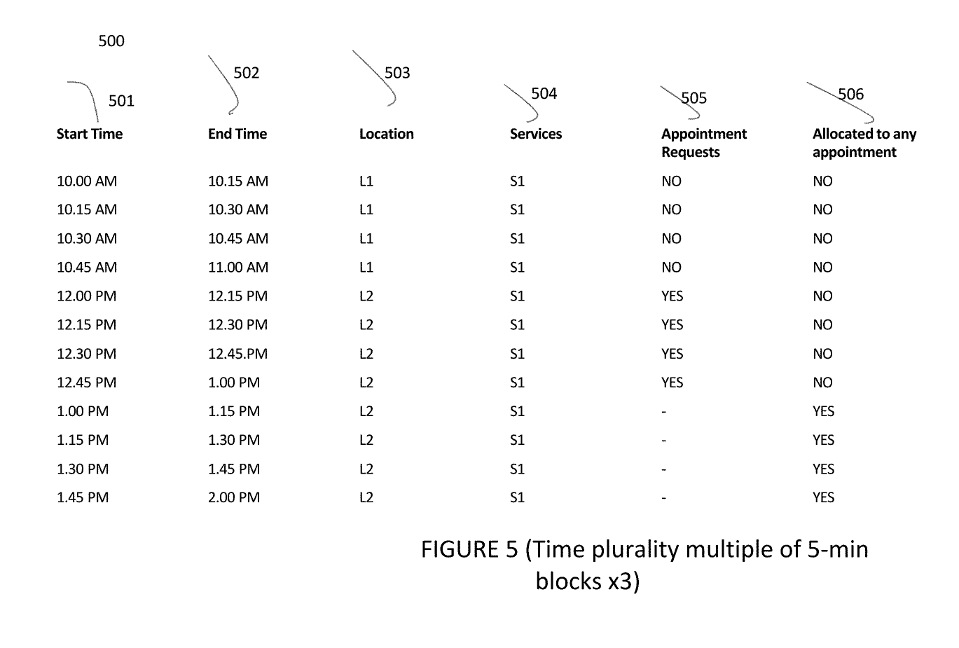

FIG. 5 500 represents the same table for net availability. The attributes of the table are start time 501, end time 502, location 503, services 504, appointment requests 505 and allocated 506. The net availability is determined as the collection of available time blocks that neither have any appointment request nor allocated to any appointment. Each group of consecutive time blocks meeting these criteria for a location are clubbed together as availability time for new appointment. In the table, the first four rows representing time from 10:00 AM to 11:00 AM are net available as they are neither requested not allocated.

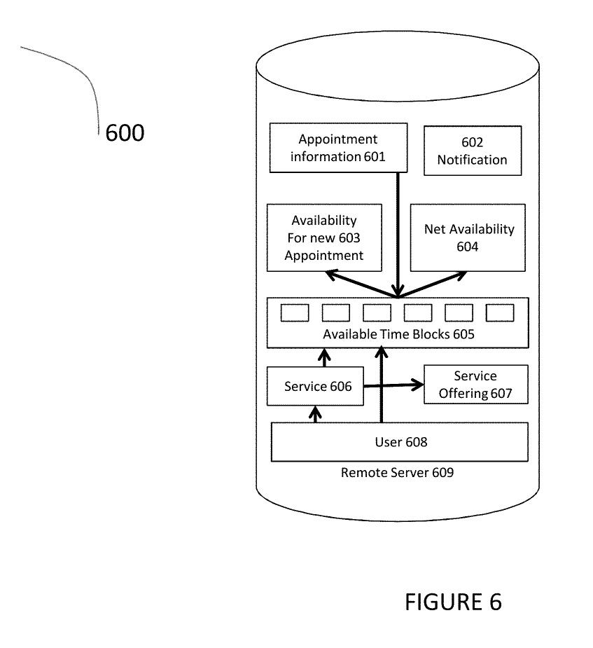

FIG. 6 600 describes a remote server 609. A remote server is a central repository of all information of application. Information stored in the remote server comprises of user information 608, service provider's services 606 and their offerings 607, available time blocks 605, availability of new appointment request 603, net availability 604, appointment information 601 and user notification 602. The information of registered users 608 is stored which includes their email address, mobile phone number and name.

A user can register his skill, service(s) 606 and provide services to other users in addition to receiving services from other service provider. The minimum required service information is a service name, service classification and user. A user becomes a service provider when he or she has an active service. User can have more than one service. A mechanism is provided for the user to activate/deactivate his or her service anytime.

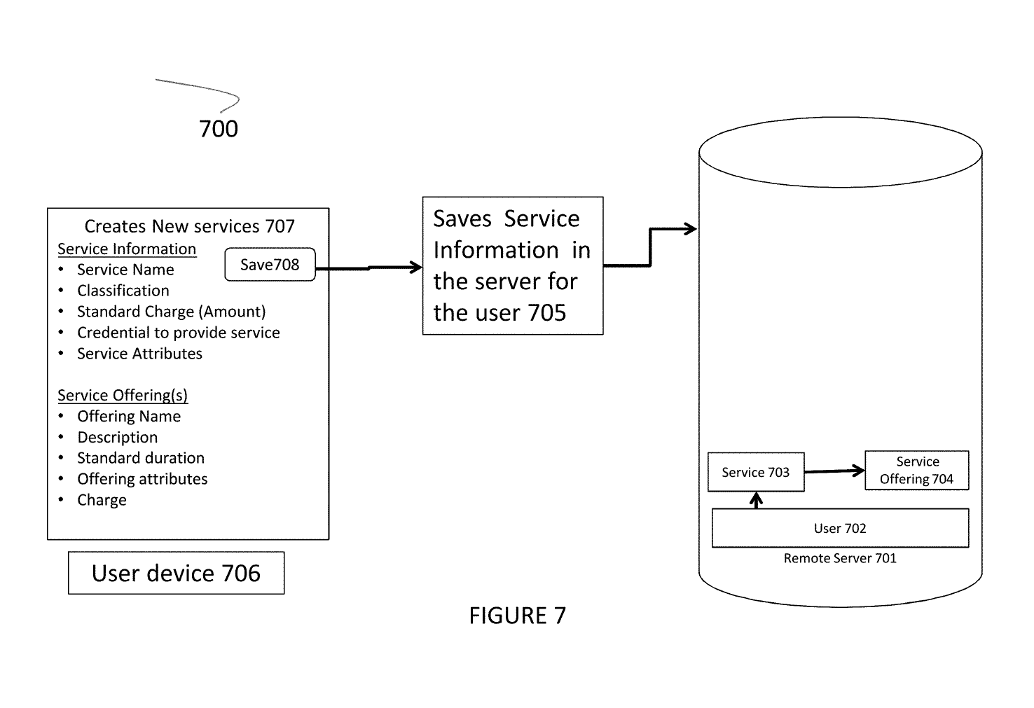

FIG. 7 700 shows a user through user device 706 creating a new service 707, which involves storing service information in the server for the user 705. The remote server 701 shows a user 702 creating a service 703 and service offering 704. The transaction key generates a save function 708 into the remote server. This completes the service registration.

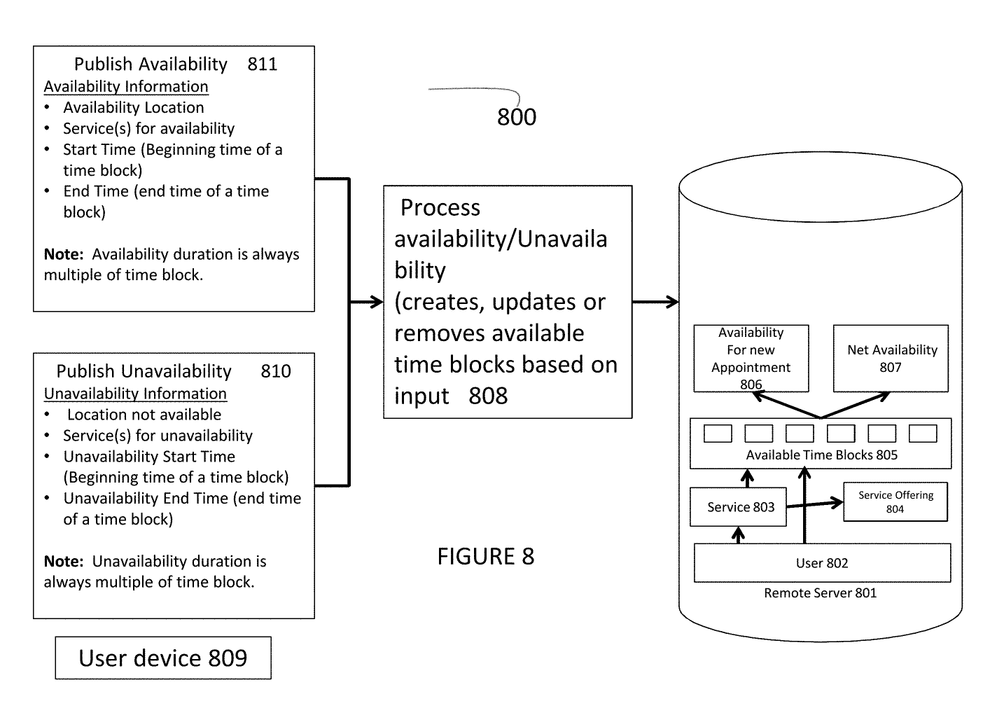

FIG. 8 800 illustrates management of availability. A user through user device 809 seeks publication of availability 811 and unavailability 810 through transaction key. This key spawns availability and unavailability processes 808, which creates, updates or removes available time blocks based on input. For the services registered in a remote server 801 as services 803 and offerings 804 with availability of time blocks 805, a net availability 807 and availability for new appointment 806 are displayed.

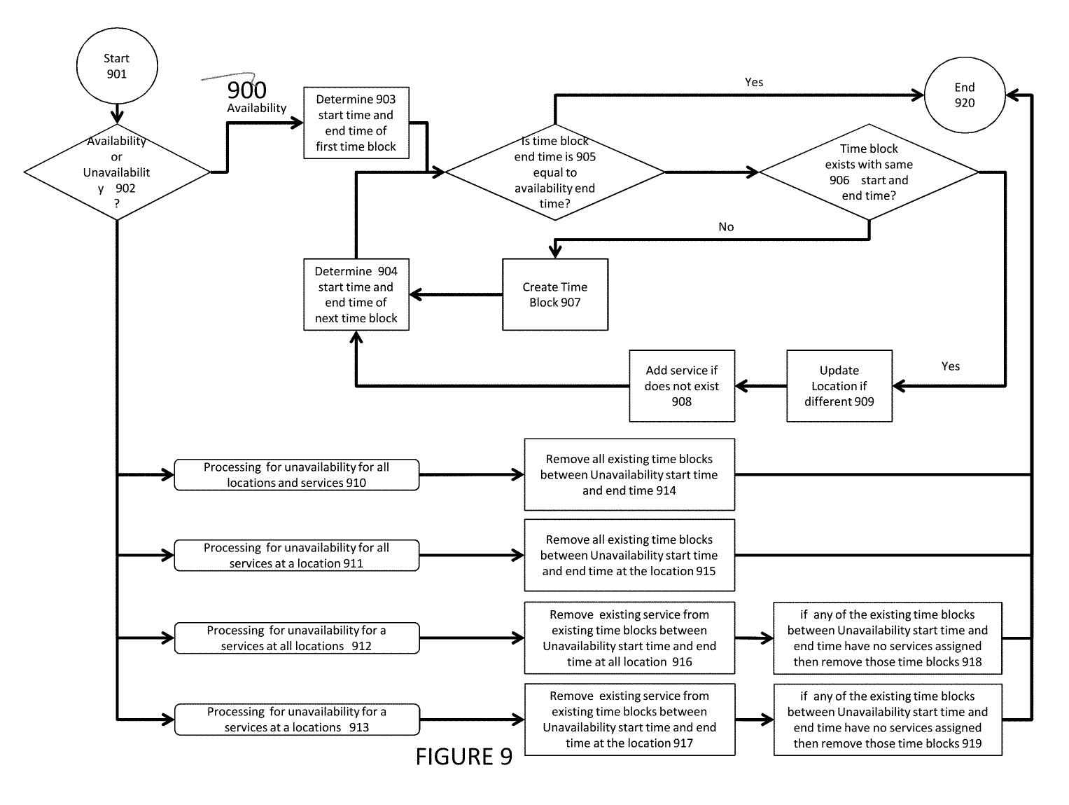

FIG. 9 900 shows a flow chart of processing availability and unavailability of time blocks. Input information for processing availability and unavailability are action (availability or unavailability), availability location, service, availability start time and availability end time. In the availability flow 902, a loop is engaged with an end of block test 903 904 with creation of time block 907 and advancement to next time block 904. Where end 920 is reached the process terminates. It otherwise proceeds with update of location 909 and addition of service 908. On the unavailability flow 902, unavailability is established per location and per service 913 912, followed by the unavailability establishment for all locations and service 910 911. With such establishment, the time blocks status is updated from start time to end time 914 915 916 917. With removal of service 916 917, the time blocks have no service associated, the corresponding time blocks are removed 918 919. The process on unavailability then ends 920.

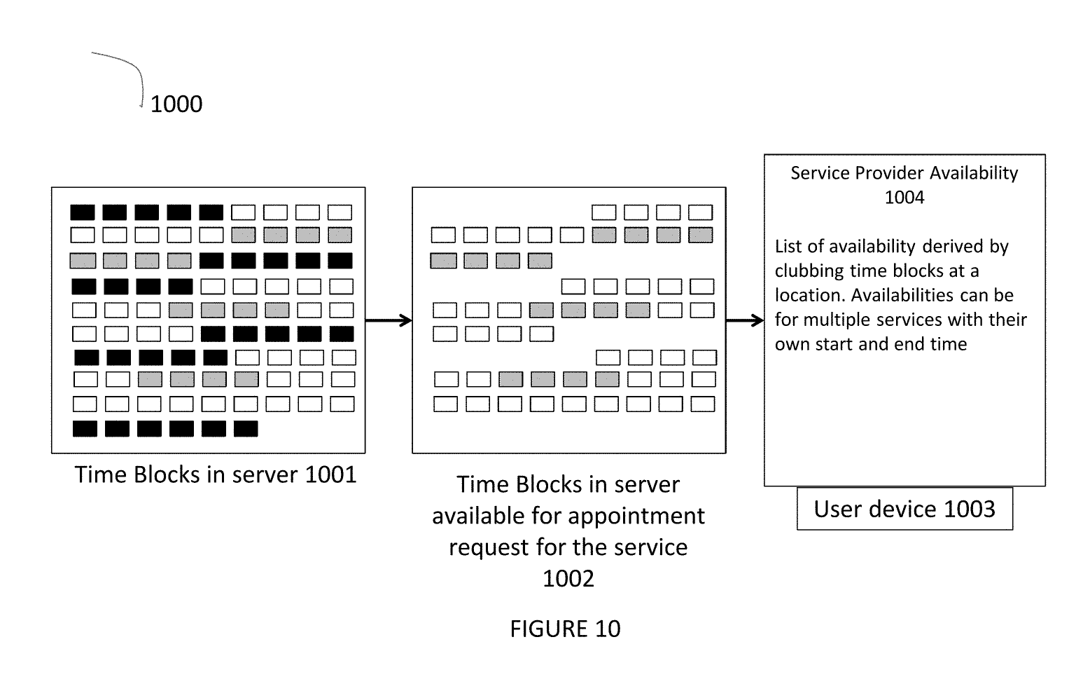

FIG. 10 1000 illustrates the process of view service provider availability for new appointment requests. From a current view of the status of the time blocks 1001, time blocks in remote server available for appointment request for the service 1002 is derived by removal of the confirmed time blocks. Clubbing time blocks at a location derives the list of availability. Availabilities can be for multiple services with their own start and end time. 1004. The transaction query is initiated by a user 1003.

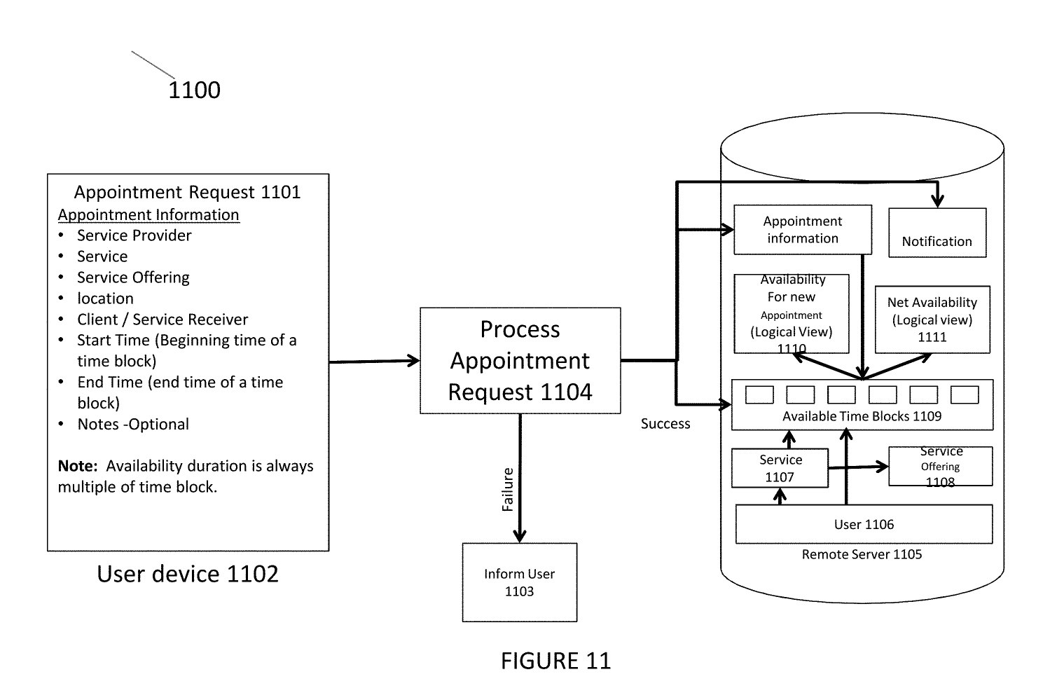

FIG. 11 1100 depicts the appointment request process 1104. A user through user device 1102 makes an appointment request 1101 with information of a service provider, service, offering, location, client/service receiver and the interval of operation 1101. Such a transaction key generates a failure and the user is informed 1103. In the alternative, success is generated which enables the update of the remote server for available time blocks 1109, new appointment availability 1110, net availability 1111, appointment information and notification to the user of success.

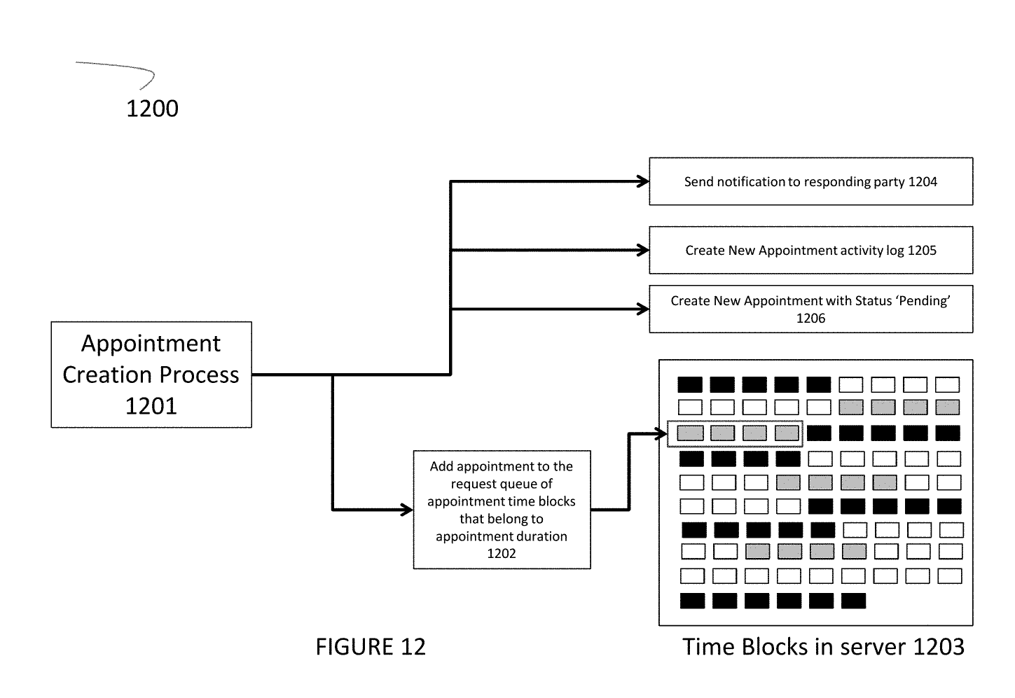

FIG. 12 1200 illustrates the execution of the appointment creation process 1201. The processes spawns a notification to the responding party 1204, new appointment activity log 1205, creation of new appointment with status pending 1206 and addition of appointment to the request time blocks that belong to appointment duration 1202 1203.

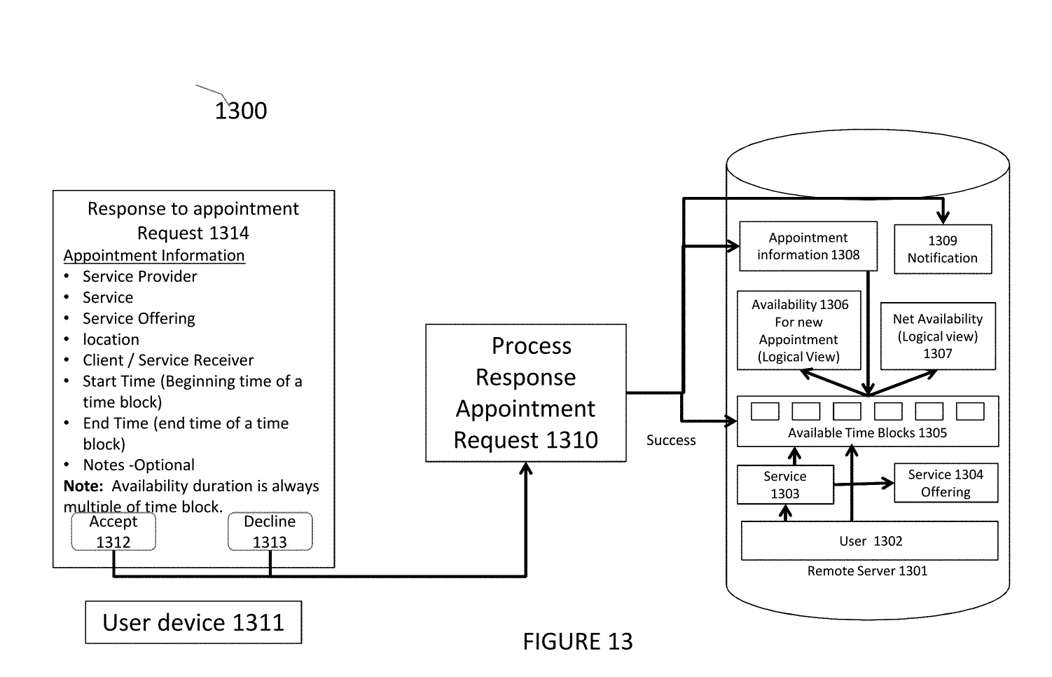

FIG. 13 1300 pictorially represents response to appointment request. Through a user device 1311 a transaction key is initiated to which a response 1314 is built using the parameters of an appointment request with either a decline output or a success output. Where success is signaled, the appropriate elements of the remote server for available time blocks 1305, availability for new appointments, net availability, notification and information are updated 1308 1309.

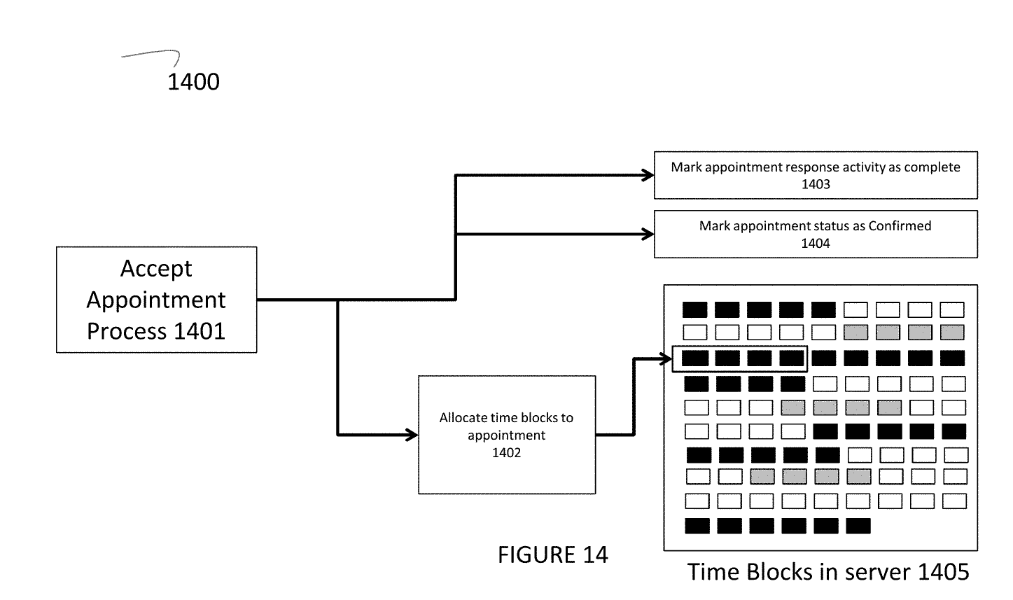

FIG. 14 1400 depicts an accept appointment process 1401. The process spawns sub-processes to mark appointment response activity as complete 1403, mark appointment status as confirmed 1404. Time blocks to appointment 1402 are allocated to the appointment in the server 1405. The status of the time blocks affected goes as confirmed and does not become available for future appointment request.

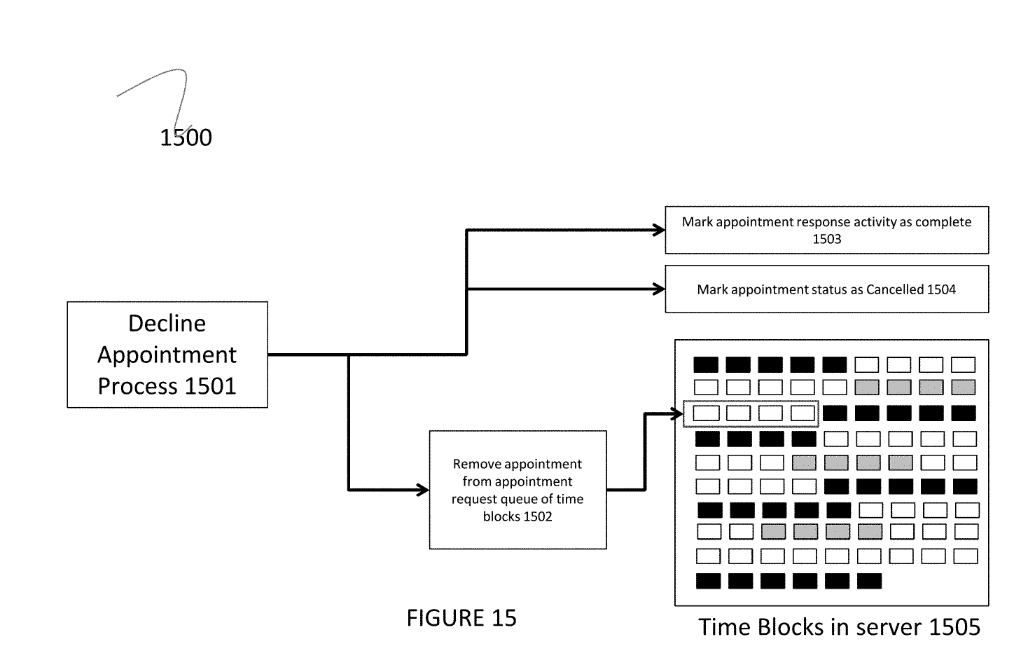

FIG. 15 1500 similarly depicts the decline appointment process 1501. Sub processes are spawned to mark appointment response activity as complete 1503, status as cancelled 1504 and appointment is removed from appointment request queue of time blocks 1502. The removal returns the affected time blocks in the empty state 1505.

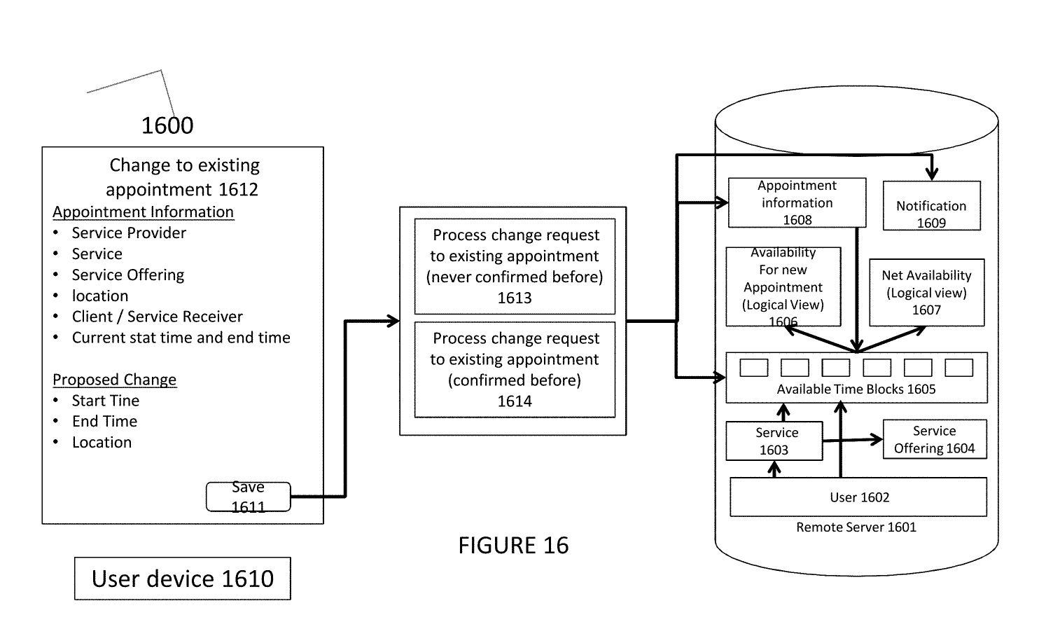

FIG. 16 1600 depicts a change request to existing appointments process and sub-processes. A user through user device 1610 makes a transaction key 1612 with appointment information and proposed change time and/or location. A save of the transaction key 1611 triggers either a process change request to existing appointment 1613 which was never confirmed before or it triggers a process change request to existing appointment, which was confirmed before 1614. In either case, an appropriate update to the remote server is triggered for available time blocks 1605, availability of new appointments 1606, net availability 1607, notification 1609 and appointment information 1608.

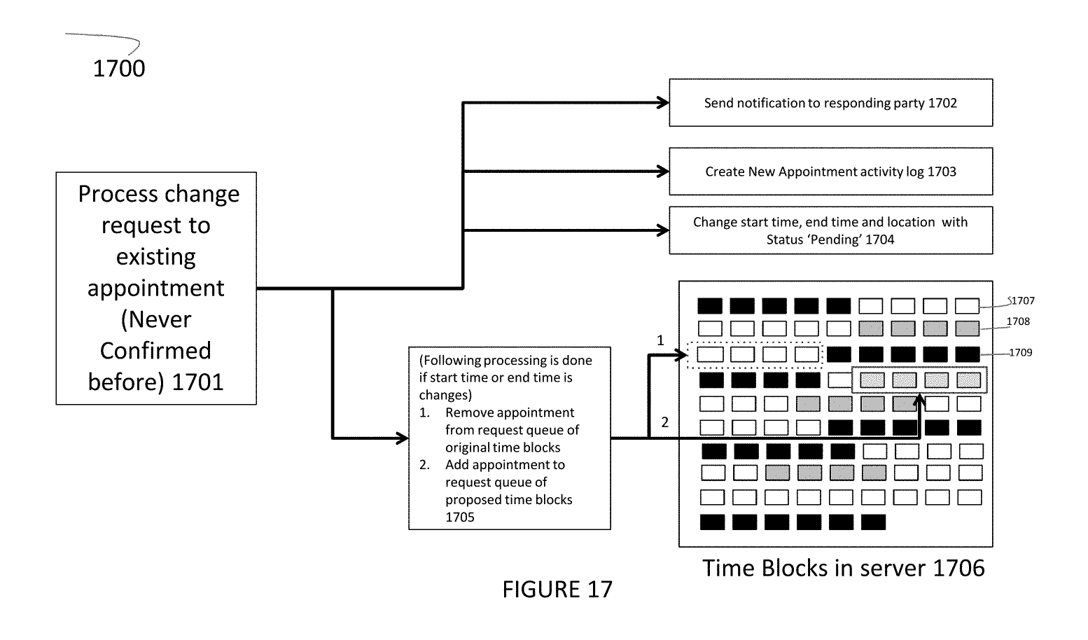

FIG. 17 1700 shows the flow of process for change request to existing appointment, which was never confirmed before 1701. If the start or end time is changed, appointment is removed from request queue of original time blocks and added to request queue of proposed time blocks 1705. The removal process restores the status of affected time blocks to be empty while the addition process changes the status of the blocks to requested 1706. Sub-processes are spawned for notification to responding party 1702, creation of new activity log 1703 and change of start time, end time and location with status pending 1704.

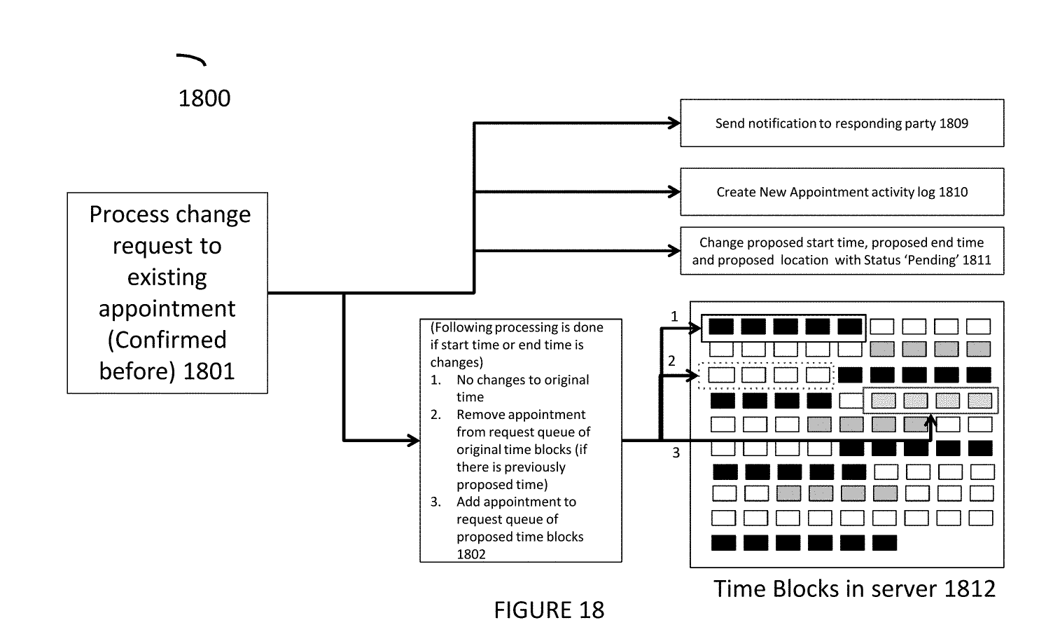

FIG. 18 1800 illustrates the same process of change request to existing appointment process which was confirmed before 1801. If the start or end time is changed, time blocks representing original appointment time remains intact and appointment request is added to request queue of time blocks representing proposed time 1802. Sub-processes to notify the responding party 1809, creation of new appointment activity log 1810 and change of proposed start time, proposed end time and proposed location with status pending 1811 are triggered. If appointment change request is accepted then appointment is confirmed to proposed time and location and time blocks representing proposed time is allocated to appointment and time block representing previously conformed time is freed up for future appointment requested. If appointment change request is declined then appointment is removed from request queue of time blocks of proposed time and appointment remains confirmed to original time and location. This ensures that even if proposed time and responding party declines the location change, the original appointment remains intact.

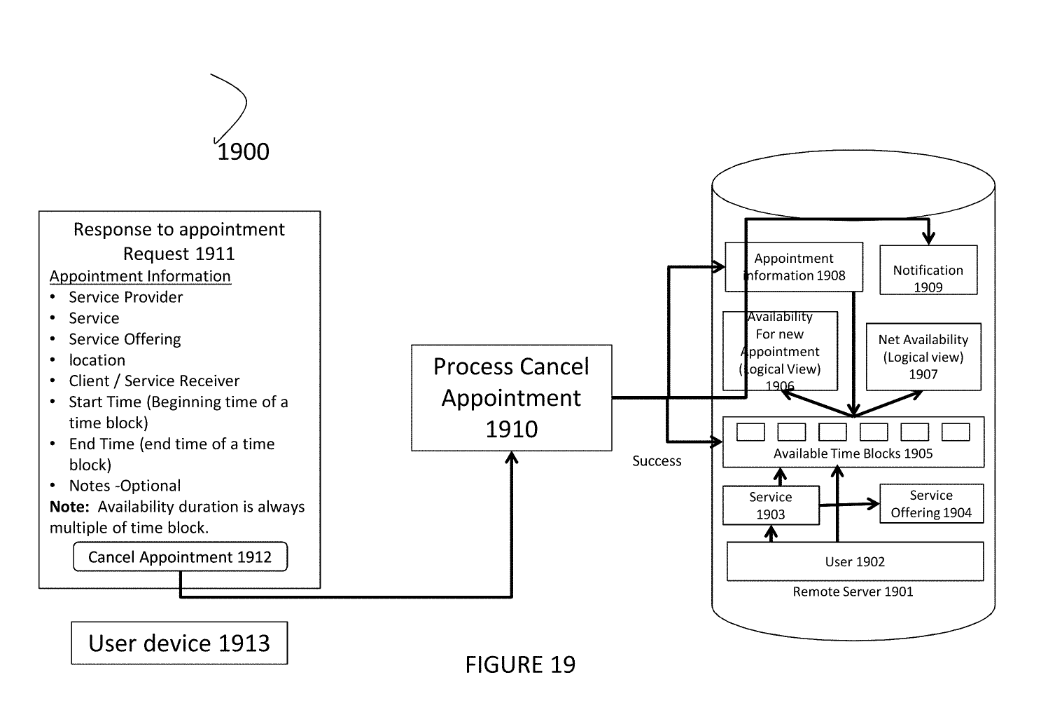

FIG. 19 1900 shows the operation of process to cancel appointment. A user through user device 1913 triggers and creates an appointment. At the initiation of the service provider, a transaction key response to appointment request 1911 with appointment information initiates a cancel appointment process over the remote server 1901. The process to cancel appointment 1910 when succeeding operates over availability for new appointments 1906, net availability 1907, appointment information 1908 and notification 1908.

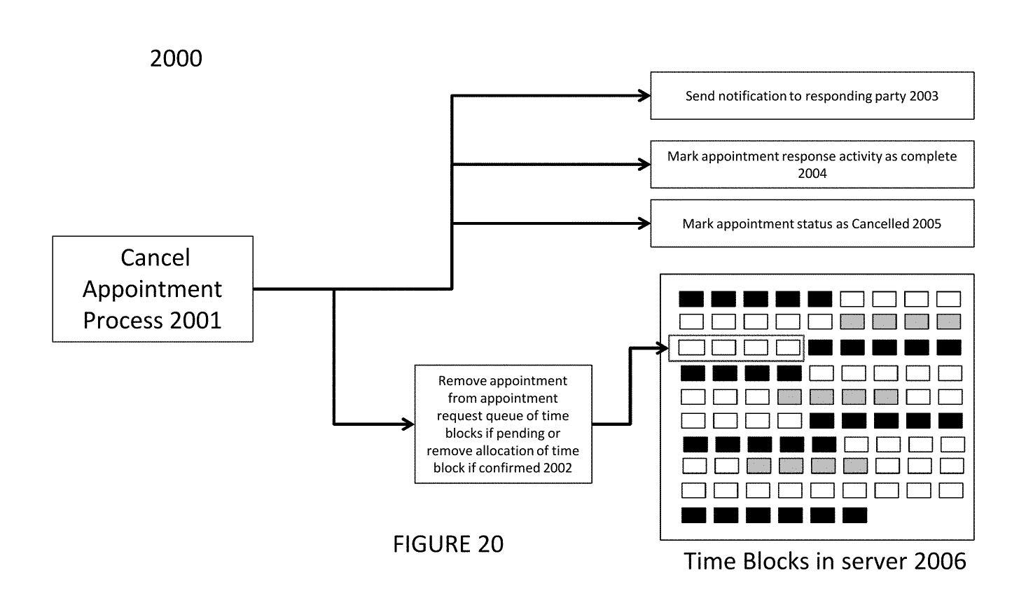

FIG. 20 2000 depicts the processes and sub-processes on a cancel appointment process 2001. A removal of appointment from appointment request queue of time blocks if pending or removal of allocation of time block if confirmed 2002 operates over the time blocks in server 2006. Also spawned are the sub-processes to mark appointment status as cancelled 2005, activity as complete 2004 and notification to responding party 2003. Notifications are notice to user to respond to a request or just information.

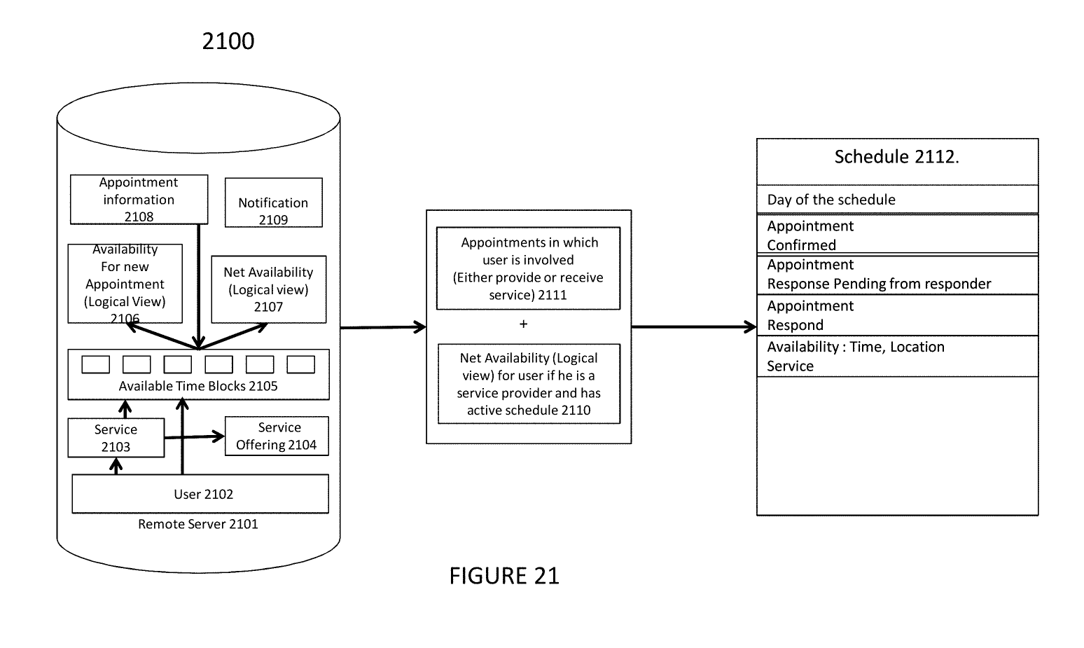

FIG. 21 2100 depicts a view schedule process. On initiation by a user 2102 through a user device, a transaction key for the view schedule accesses the remote server 2101, the service 2103, offerings 2104, the available time blocks 2105, the net availability 2107, availability for new appointment 2106, appointment information 2108 and notification 2109. Based on the user information, appointments involving the user 2111 and net availability 2110 are displayed as the schedule 2112 comprising of information on day of the schedule, confirmed appointment, appointment response pending, appointment respond and availability in terms of location, service and time.

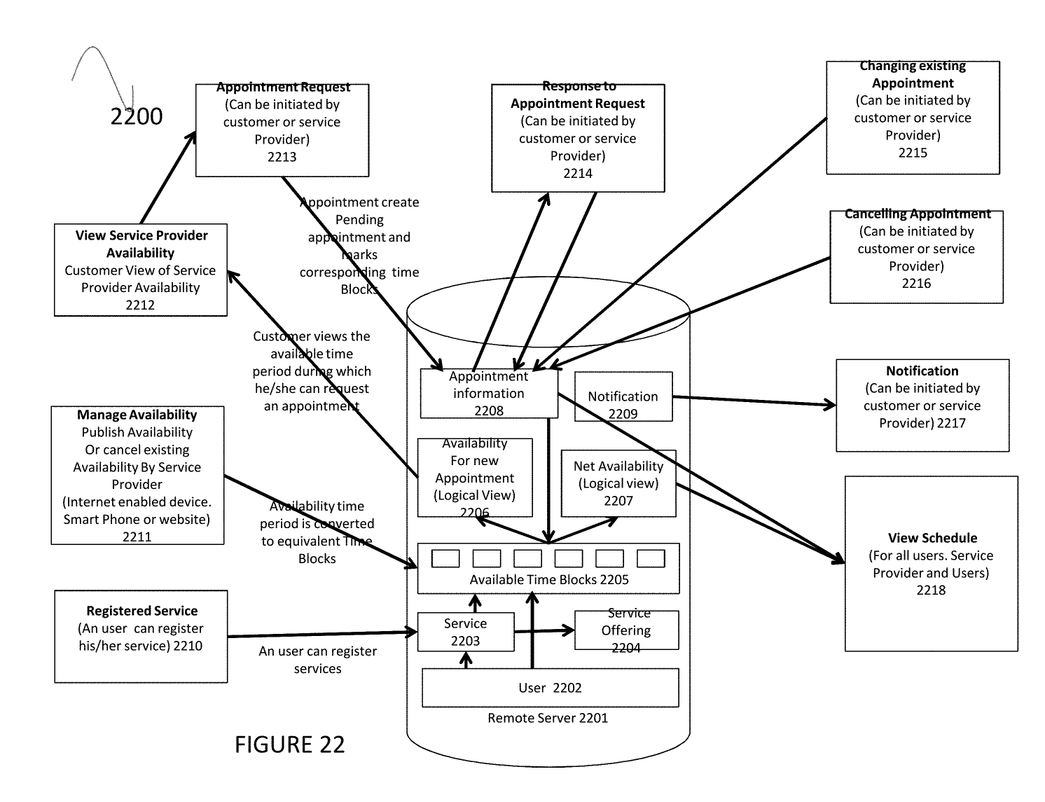

FIG. 22 2200 provides a comprehensive diagram view of the solution framework. A remote server 2201 has information on user 2202, service 2203, service offering 2204, time blocks 2205, and availability for new appointment 2206, net availability 2207, appointment information 2208 and notification 2209. A registered service 2210 communicates with service module 2203. Manage availability 2211 process communicates with available time blocks 2205. A view service provider availability 2212 lets a customer view the available time period during which he/she an request an appointment. An appointment request 2213 initiated by user or service provider 2213 communicates with appointment information block of the remote server 2208. A response to appointment request 2214 initiated by user or service provider also communicates with appointment information block If appointment change request is accepted then appointment is confirmed to proposed time and location and time blocks representing proposed time is allocated to appointment and time block representing previously conformed time is freed up for future appointment requested. If appointment change request is declined then appointment is removed from request queue of time blocks of proposed time and appointment remains confirmed to original time and location. This ensures even if proposed time and location of change request is declined by responding party, the original appointment remains intact. Processes of changing existing appointment 2215, cancellations of appointment 2216 communicate with the appointment information 2208. Notification 2217 initiated by user or service provider communicates with the notification component 2209 of the remote server 2201. The view schedule process 2218 accesses the remote server 2201 in its appointment information 2208 and net availability 2207 modules.

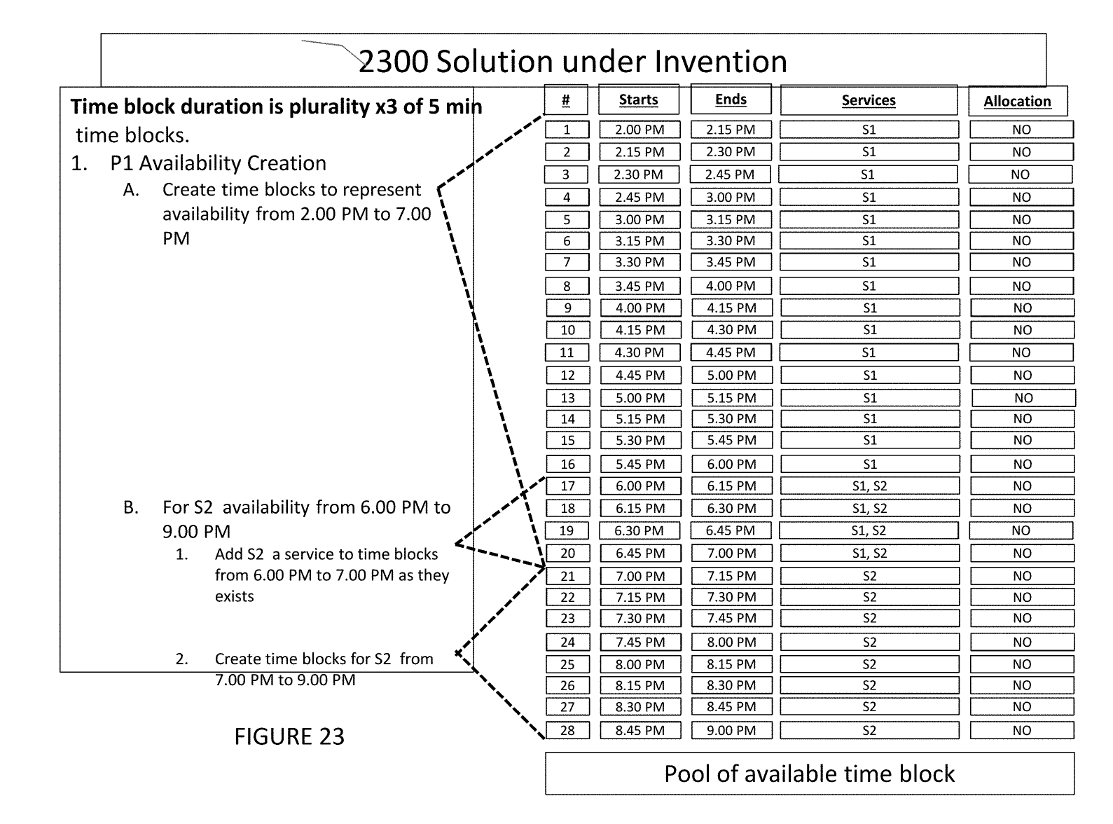

FIG. 23 2300 shows the scheduling of appointment for service provider P1 offering services S1 and S2. S1 is offered from 2 PM to 7 PM. S2 is offered from 6 PM to 9 PM. For an hour, P1 can provide both services S1 and S2, based on his bookings. For each service, the time blocks are allocated. The pool of available time blocks are maintained as a table of attributes start, end, services and allocation status.

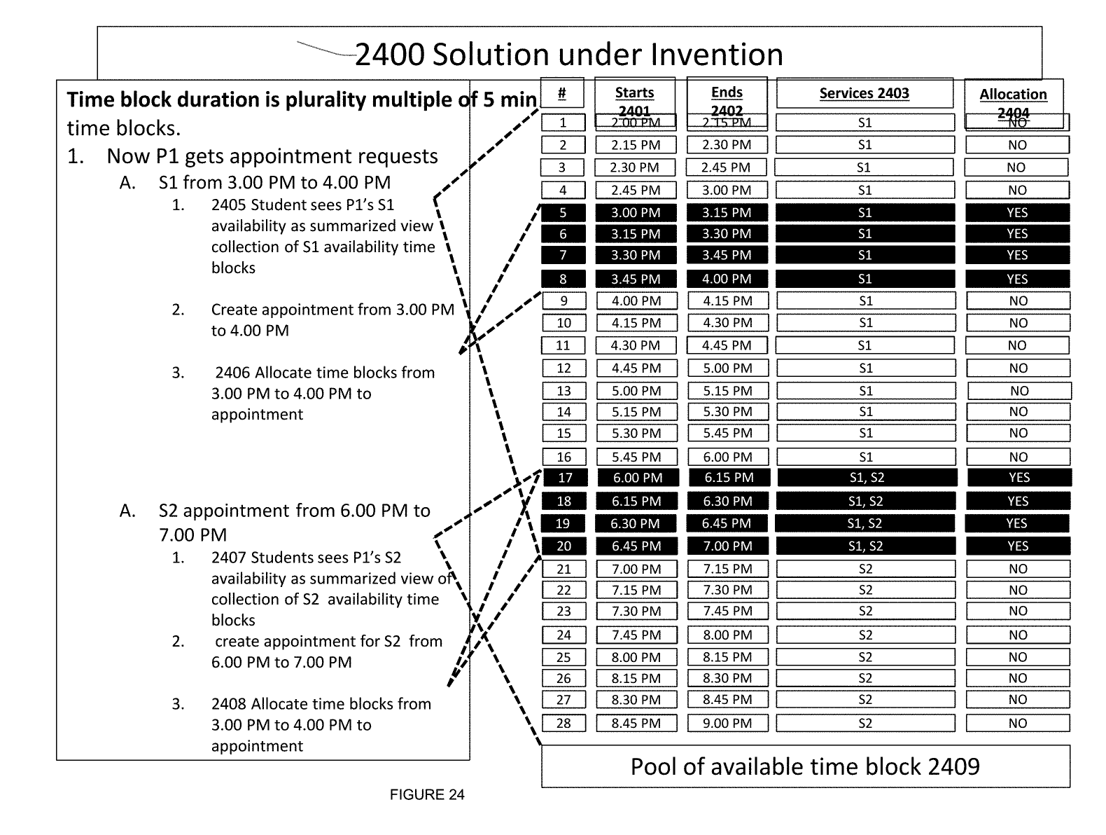

FIG. 24 2400 shows the same table booked for appointment for S1 service provided by P1 from 3 PM to 4 PM. The same table also shows scheduled appointment for S2 for S2 service provided by P1 from 6 PM to 7 PM. During this period, S1 is also offered but the provider resource P1 is only one. The allocation column is changed for the time blocks involved to be marked as allocated.

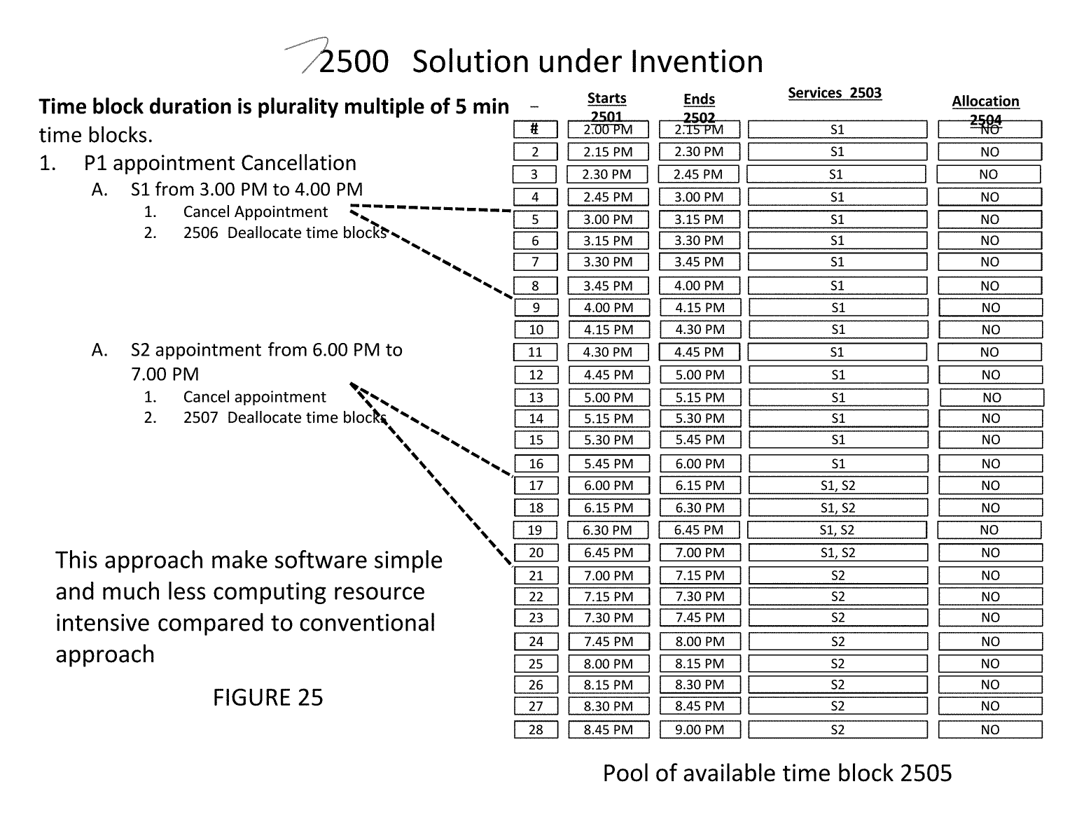

FIG. 25 2500 cancels the scheduled appointments for S1 and S2 and provider P1. The allocation column is restored to unallocated status.

The examples provided above are exemplary only and are not intended to be limiting. One skilled in the art may readily devise other systems consistent with the disclosed embodiments, which are intended to be within the scope of this disclosed.

What is claimed is:

1. An integrated appointment scheduling and management system, comprising:
a plurality of computer systems with memory, peripherals, fixed and removable media, processor connected through buses or networks and;
a plurality of vendors making offerings of a plurality of services and their availability;
a plurality of users seeking a plurality of services in desired time periods;
a use of the computer systems to match the availability and the offerings of services to the sought services and time periods between vendors and users.

2. The integrated appointment scheduling and management system of claim 1 where the desired time periods are a plurality multiple of a fixed time duration.

3. The integrated appointment scheduling and management system of claim 1 where the desired time periods are delinked with the service time availability.

4. The integrated appointment scheduling and management system of claim 1 where the management comprises cancellation or change of prior appointment.

5. The integrated appointment scheduling and management system of claim 1 where management comprises addition and removal of vendors.

6. The integrated appointment scheduling and management system of claim 1 where management comprises of registration and de-registration of users.

7. An integrated appointment scheduling and management device, comprising:
a plurality of computer systems with memory, peripherals, fixed and removable media, processor connected through buses or networks and;
a plurality of vendors making offerings of a plurality of services and their availability;
a plurality of users seeking a plurality of services in desired time periods; a use of the computer systems to match the availability and the offerings of services to the sought services and time periods between vendors and users.

8. The integrated appointment scheduling and management device of claim 7 where the desired time periods are a plurality multiple of a fixed time duration.

9. The integrated appointment scheduling and management device of claim 7 where the desired time periods are delinked with the service time availability.

10. The integrated appointment scheduling and management device of claim 7 where the management comprises cancellation or change of prior appointment.

11. The integrated appointment scheduling and management device of claim 7 where management comprises addition and removal of vendors.

12. The integrated appointment scheduling and management device of claim 7 where management comprises of registration and de-registration of users.

13. A method for appointment scheduling and management comprising:
a plurality of vendors making offerings of a plurality of services and their availability;
a plurality of users seeking a plurality of services in desired time periods;
a use of a plurality of computer systems to match the availability and the offerings of services to the sought services and time periods between vendors and users.

14. The integrated appointment scheduling and management method of claim 13 where the desired time periods are a plurality multiple of a fixed time duration.

15. The integrated appointment scheduling and management method of claim 13 where the desired time periods are delinked with the service time availability.

16. The integrated appointment scheduling and management method of claim 13 where the management comprises cancellation or change of prior appointment.

17. The integrated appointment scheduling and management method of claim 13 where management comprises addition and removal of vendors.

18. The integrated appointment scheduling and management method of claim 13 where management comprises of registration and de-registration of users.
